(19) United States
(12) Patent Application Publication
(10) Pub. No.: US 2025/0304504 A1
(43) Pub. Date: Oct. 2, 2025

(54) HONEYCOMB STRUCTURE, FORMING RAW MATERIAL COMPOSITION, AND METHOD FOR PRODUCING POROUS BODY

(71) Applicant: NGK INSULATORS, LTD., Nagoya-City (JP)

(72) Inventors: Yusuke TSUCHIYA, Nagoya-Shi (JP); Atsuki KITAMURA, Nagoya-Shi (JP)

(73) Assignee: NGK INSULATORS, LTD., Nagoya-City (JP)

(21) Appl. No.: 19/070,875

(22) Filed: Mar. 5, 2025

(30) Foreign Application Priority Data
Mar. 29, 2024 (JP) 2024-058071

(51) Int. Cl. C04B 35/565; B01J 27/182; B01J 35/57; C04B 35/63; C04B 35/64; C04B 38/00

(52) U.S. Cl. CPC C04B 35/565; B01J 27/182; B01J 35/57; C04B 35/6316; C04B 35/64; C04B 38/0009; C04B 2235/3213; C04B 2235/3217; C04B 2235/3418; C04B 2235/3445; C04B 2235/3826; C04B 2235/428; C04B 2235/6021; C04B 2235/9607

(57) ABSTRACT

A honeycomb structure includes partition walls that define a plurality of cells extending from one end surface to the other end surface, wherein the partition walls include silicon carbide, silicon, and a firing aid, wherein the firing aid includes aluminum oxide, silicon oxide, and strontium oxide, and assuming a total parts by mass of the aluminum oxide, the silicon oxide, and the strontium oxide with respect to the total of 100 parts by mass of the silicon carbide and the silicon in the partition walls is T₁, and a part by mass of the aluminum oxide with respect to the total of 100 parts by mass of the silicon carbide and the silicon in the partition walls is A₁, 0.045≤A₁/T₁ is satisfied.

### CROSS REFERENCE TO RELATED APPLICATIONS

The present invention claims the benefit of priority to Japanese Patent Application No. 2024-58071 filed on Mar. 29, 2024 with the Japanese Patent Office, the entire contents of which are incorporated herein by reference in its entirety.

### FIELD OF THE INVENTION

The present invention relates to a honeycomb structure. Further, the present invention also relates to a forming raw material composition and a method for producing a porous body using the same.

### BACKGROUND OF THE INVENTION

Silicon carbide (SiC) is used in a variety of ceramic products such as heat sinks, exhaust gas filters, catalyst carriers, sliding parts, nozzles, heat exchangers, and semiconductor manufacturing equipment parts, taking advantage of its properties such as high heat resistance, high hardness, excellent chemical resistance, and excellent wear resistance. In particular, silicon-silicon carbide composites have excellent properties such as heat resistance, thermal shock resistance, and oxidation resistance, and are known as a representative constituent material of honeycomb structures used in filters (for example, DPFs) that collect fine particles in exhaust gases from internal combustion engines, boilers, etc., and as catalyst carriers for exhaust gas purification catalysts.

A honeycomb structure containing a silicon-silicon carbide composite material is produced, for example, by adding silicon (Si), a pore-forming material, and a firing aid to silicon carbide powder, kneading the mixture to obtain a green body, extruding the green body into a honeycomb formed body using a predesigned die, and firing the resulting honeycomb formed body. A known firing aid includes aluminum oxide (Al₂O₃), silicon oxide (SiO₂), and alkaline earth metal oxides (oxides of Mg, Ca, Sr, and Ba), and the addition of the firing aid can improve the wetting of silicon (Si) to silicon carbide during melting, thereby increasing the bonding strength (Patent Literature 1 and 2).

### PRIOR ART

### Patent Literature

[Patent Literature 1] Japanese Patent No. 6043340
[Patent Literature 2] WO 2012/132837

### SUMMARY OF THE INVENTION

In recent years, DPFs and catalyst carriers have become larger in size and have more complex cell structures, and the environments in which they are used have become harsher. Therefore, honeycomb structures used for these applications are required to have further improved thermal shock resistance. It is known that one of the effective means for improving thermal shock resistance is to suppress the thermal expansion of a honeycomb structure, and it is desirable to develop a new technology that can suppress the thermal expansion of a honeycomb structure.

In view of the above circumstances, an object of one embodiment of the present invention is to provide a honeycomb structure containing a silicon-silicon carbide composite material capable of suppressing thermal expansion. Further, an object of another embodiment of the present invention is to provide a forming raw material composition and a method for producing a porous body suitable for producing such a honeycomb structure.

The present inventors have conducted intensive research to solve the above problems and have discovered that, by adding aluminum oxide, silicon oxide and strontium oxide as the firing aid under certain conditions, a honeycomb structure containing a silicon-silicon carbide composite material in which thermal expansion is significantly suppressed can be obtained. Since the thermal stress is reduced by suppressing the thermal expansion, it becomes possible to improve the thermal shock resistance of the honeycomb structure. The present invention, which was completed based on the above findings, is exemplified as below.

### [Aspect 1]

A honeycomb structure, comprising partition walls that define a plurality of cells extending from one end surface to the other end surface,
wherein the partition walls comprise silicon carbide, silicon, and a firing aid,
wherein the firing aid comprises aluminum oxide, silicon oxide, and strontium oxide, and assuming a total parts by mass of the aluminum oxide, the silicon oxide, and the strontium oxide with respect to a total of 100 parts by mass of the silicon carbide and the silicon in the partition walls is T₁, and a part by mass of the aluminum oxide with respect to the total of 100 parts by mass of the silicon carbide and the silicon in the partition walls is A₁, 0.045≤A₁/T₁ is satisfied.

### [Aspect 2]

The honeycomb structure according to aspect 1, wherein 0.045≤A₁/T₁≤0.200 is satisfied.

### [Aspect 3]

The honeycomb structure according to aspect 1 or 2, wherein assuming a part by mass of the silicon oxide with respect to the total of 100 parts by mass of the silicon carbide and the silicon in the partition walls is B₁, 0.70≤B₁/T₁≤0.90 is satisfied.

### [Aspect 4]

The honeycomb structure according to any one of aspects 1 to 3, wherein assuming a part by mass of the strontium oxide with respect the total of 100 parts by mass of the silicon carbide and the silicon in the partition walls is C₁, 0.050≤C₁/T₁≤0.200 is satisfied.

### [Aspect 5]

The honeycomb structure according to any one of aspects 1 to 4, wherein 10≤T₁≤40 is satisfied.

### [Aspect 6]

The honeycomb structure according to any one of aspects 1 to 5, wherein assuming a part by mass of the silicon carbide with respect to the total of 100 parts by mass of the silicon carbide and the silicon in the partition walls is D₁, 70≤D₁≤95 is satisfied.

### [Aspect 7]

The honeycomb structure according to any one of aspects 1 to 6, wherein assuming a total mass concentration of the silicon carbide and the silicon in the partition walls is E₁% by mass, 60≤E₁≤95 is satisfied.

### [Aspect 8]

The honeycomb structure according to any one of aspects 1 to 7, wherein the partition walls comprise sepiolite.

### [Aspect 9]

The honeycomb structure according to any one of aspects 1 to 8, wherein assuming a part by mass of the sepiolite with respect to the total of 100 parts by mass of the silicon carbide and the silicon is F₁, 0.5≤F₁≤5.0 is satisfied.

### [Aspect 10]

The honeycomb structure according to any one of aspects 1 to 9, wherein a porosity of the partition walls is 40% or more.

### [Aspect 11]

The honeycomb structure according to any one of aspects 1 to 10, comprising sealing portions disposed at predetermined openings of the cells at the one end surface and at remaining openings the cells at the other end surface.

### [Aspect 12]

The honeycomb structure according to any one of aspects 1 to 11, wherein an average linear expansion coefficient measured in accordance with JIS R1618: 2002 when a temperature is changed from 40° C. to 800° C. is 5.5×10⁻⁶/K or less.

### [Aspect 13]

The honeycomb structure according to any one of aspects 1 to 12, having a thermal conductivity of 3.0 W/(m·K) or more as measured at 50° C. in accordance with a method of ASTM E1530.

### [Aspect 14]

A forming raw material composition, comprising silicon carbide, silicon, a pore-forming material, and a firing aid,
wherein the firing aid comprises aluminum oxide, silicon oxide, and strontium oxide, and assuming a total parts by mass of the aluminum oxide, the silicon oxide, and the strontium oxide with respect to a total of 100 parts by mass of the silicon carbide and the silicon is T₂, and a part by mass of the aluminum oxide with respect to the total of 100 parts by mass of the silicon carbide and the silicon is A₂, 0.20≤A₂/T₂ is satisfied.

### [Aspect 15]

The forming raw material composition according to aspect 14, wherein 0.20≤A₂/T₂≤0.60 is satisfied.

### [Aspect 16]

The forming raw material composition according to aspect 14 or 15, wherein assuming a part by mass of the silicon oxide with respect to the total of 100 parts by mass of the silicon carbide and the silicon is B₂, 0.20≤B₂/T₂≤0.60 is satisfied.

### [Aspect 17]

The forming raw material composition according to any one of aspects 14 to 16, wherein assuming a part by mass of the strontium oxide with respect to the total of 100 parts by mass of the silicon carbide and the silicon is C₂, 0.10≤C₂/T₂≤0.50 is satisfied.

### [Aspect 18]

The forming raw material composition according to any one of aspects 14 to 17, wherein 1.0≤T₂≤10.0 is satisfied.

### [Aspect 19]

The forming raw material composition according to any one of aspects 14 to 18, wherein assuming a part by mass of the silicon carbide with respect to the total of 100 parts by mass of the silicon carbide and the silicon is D₂, 70≤D₂≤95 is satisfied.

### [Aspect 20]

The forming raw material composition according to any one of aspects 14 to 19, further comprising sepiolite.

### [Aspect 21]

The forming raw material composition according to aspect 20, wherein assuming a part by mass of the sepiolite with respect to the total of 100 parts by mass of the silicon carbide and the silicon is F₂, 0.5≤F₂≤5.0 is satisfied.

### [Aspect 22]

The forming raw material composition according to any one of aspects 14 to 21, wherein assuming a part by mass of the pore-forming material with respect to the total of 100 parts by mass of the silicon carbide and the silicon is G₂, 1.0≤G₂≤30.0 is satisfied.

### [Aspect 23]

A method for producing a porous body, comprising:
a forming step in which the forming raw material composition according to any one of aspects 14 to 22 is extruded to prepare a formed body, and
a firing step in which the formed body is fired to prepare a porous body.

### [Aspect 24]

The method for producing a porous body according to aspect 23, wherein the formed body comprises partition walls that define a plurality of cells extending from one end surface to the other end surface.

According to one embodiment of the present invention, it is possible to provide a honeycomb structure containing a silicon-silicon carbide composite material capable of suppressing thermal expansion. As there is an increasing need in the market for honeycomb structures containing a silicon-silicon carbide composite material with further improved thermal shock resistance, said honeycomb structure can meet such market needs. Further, according to another embodiment of the present invention, it is possible to provide a forming material composition and a method for producing a porous body suitable for producing such a honeycomb structure.

### BRIEF DESCRIPTION OF THE DRAWINGS

FIG. 1 is a perspective view showing a typical wall-through type honeycomb structure.

FIG. 2 is a schematic cross-sectional view of a wall-through type honeycomb structure observed from a cross section parallel to the direction in which the cells extend.

FIG. 3 is a perspective view showing a typical wall-flow type pillar-shaped honeycomb structure.

FIG. 4 is a schematic cross-sectional view of a wall-flow type pillar-shaped honeycomb structure observed from a cross section parallel to the direction in which the cells extend.

FIG. 5 is a schematic end view (a) and side view (b) of a honeycomb structure provided as a segment-joined body.

### DETAILED DESCRIPTION OF THE INVENTION

Hereinafter, the embodiments of the present invention will be described in detail, but the present invention should not be regarded as being limited to these embodiments, and various modifications and improvements can be made based on the knowledge of those skilled in the art without departing from the spirit of the present invention. The components disclosed in each embodiment can be appropriately combined to form various inventions. For example, some components may be omitted from all the components shown in the embodiments, or components of different embodiments may be appropriately combined.

### (1. Honeycomb Structure)

A honeycomb structure according to one embodiment of the present invention includes partition walls that partition a plurality of cells extending from one end surface to the other end surface. In one embodiment, the honeycomb structure is provided as a wall-through type honeycomb structure in which both one end surface and the other end surface of a plurality of cells have openings. In another embodiment, the honeycomb structure is provided as a wall-flow type honeycomb structure having sealing portions disposed at the predetermined openings of the cells at the one end surface and the remaining openings of the cells at the other end surface. The honeycomb structure is not particularly limited in its application, and may be used in various industrial applications, such as heat sinks, filters (for example, GPF, DPF), catalyst carriers, sliding parts, nozzles, heat exchangers, electrical insulating members, and parts for semiconductor manufacturing equipment. Among these, it can be suitably used as a filter for collecting particulate matter contained in exhaust gas from an internal combustion engine, a boiler, or the like, and as a catalyst carrier for an exhaust gas purification catalyst. In particular, the honeycomb structure can be suitably used as an exhaust gas filter and/or a catalyst carrier for automobiles.

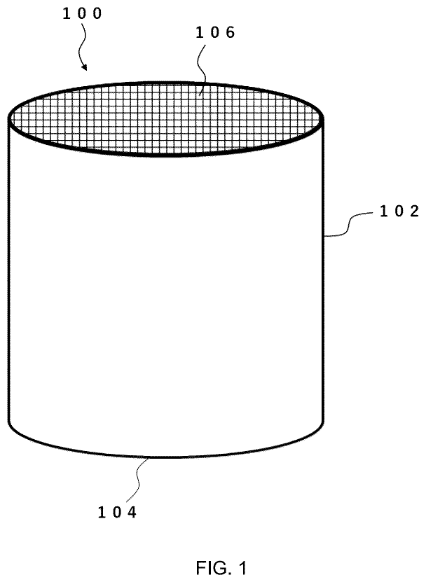

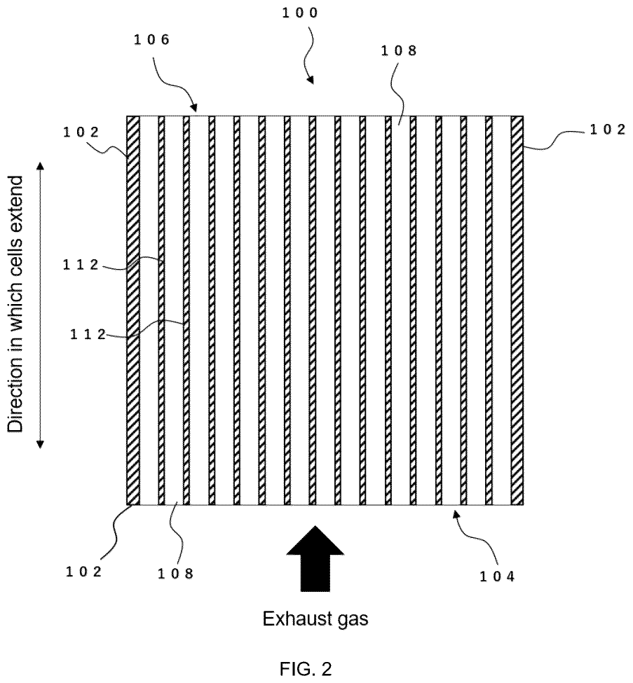

FIGS. 1 and 2 are a schematic perspective view and a cross-sectional view, respectively, of a wall-through type honeycomb structure 100. This honeycomb structure 100 comprises an outer peripheral side wall 102, and partition walls 112 disposed on the inner peripheral side of the outer peripheral side wall 102 and defining a plurality of cells 108 that form fluid flow paths (cell channels) from a first end surface 104 to a second end surface 106. In this honeycomb structure 100, both ends of each cell 108 are open, and exhaust gas that flows into one cell 108 from the first end surface 104 is purified while passing through the cell, and flows out from the second end surface 106. In addition, in this embodiment, the first end surface 104 is located on the upstream side of the exhaust gas and the second end surface 106 is located on the downstream side of the exhaust gas, but the distinction between the first end surface and the second end surface is for convenience, and the second end surface 106 may be located on the upstream side of the exhaust gas and the first end surface 104 may be located on the downstream side of the exhaust gas.

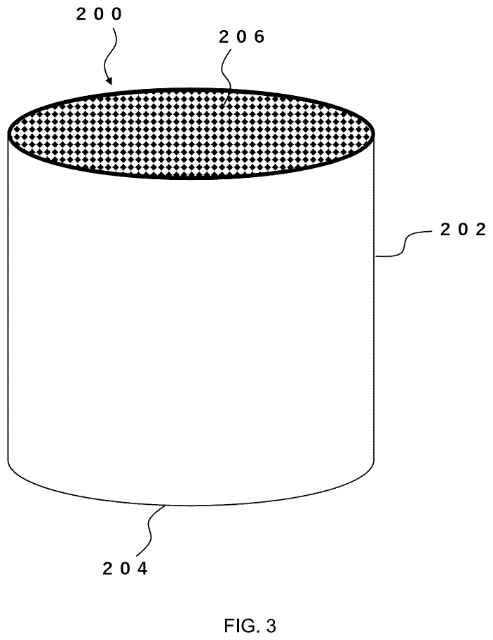

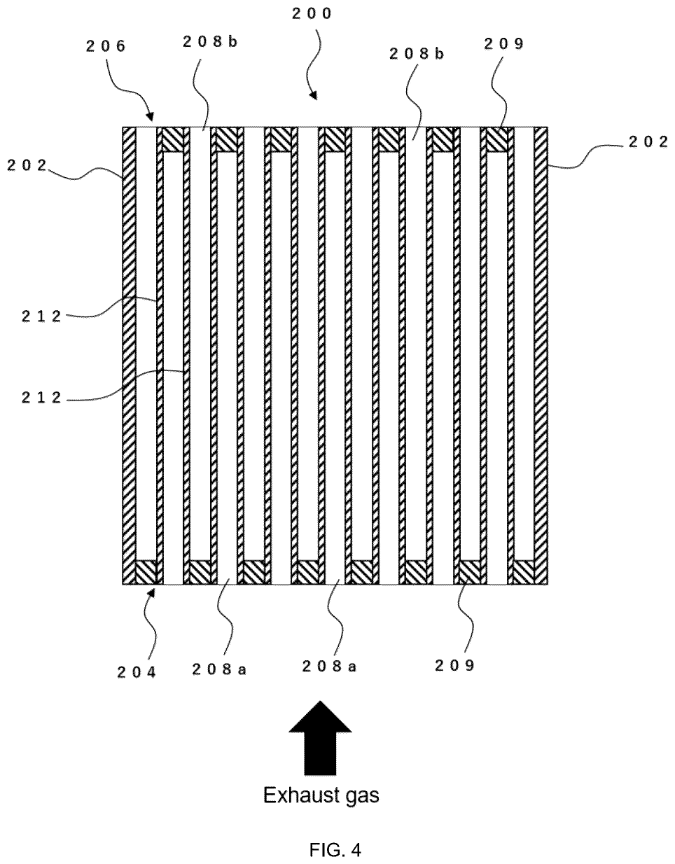

FIGS. 3 and 4 are a schematic perspective view and a cross-sectional view, respectively, of a wall-flow type honeycomb structure 200. This honeycomb structure 200 comprises an outer peripheral side wall 202, and partition walls 212 disposed on the inner peripheral side of the outer peripheral side wall 202 and defining a plurality of cells 208a, 208b that form fluid flow paths (cell channels) from a first end surface 204 to a second end surface 206. In the honeycomb structure 200, the plurality of cells 208a, 208b can be divided into a plurality of first cells 208a disposed on the inner peripheral side of the outer peripheral side wall 202, extending from the first end surface 204 to the second end surface 206, opening on the first end surface 204, and having sealing portions 209 on the second end surface 206; and a plurality of second cells 208b disposed on the inner peripheral side of the outer peripheral side wall 202, extending from the first end surface 204 to the second end surface 206, having sealing portions 209 on the first end surface 204, and opening on the second end surface 206. In addition, in this honeycomb structure 200, the first cells 208a and the second cells 208b are alternately arranged adjacent to each other with the partition walls 212 interposed therebetween.

When exhaust gas containing particulate matter such as soot is supplied to the first end surface 204 on the upstream side of the honeycomb structure 200, the exhaust gas is introduced into the first cells 208a and travels downstream within the first cells 208a. Since the first cells 208a have sealing portions 209 on the second end surface 206 on the downstream side, the exhaust gas passes through the partition walls 212 that separates the first cells 208a and the second cells 208b and flows into the second cells 208b. Since the particulate matter cannot pass through the partition walls 212, it is collected and deposited within the first cells 208a. After the particulate matter is removed, the clean exhaust gas that has flowed into the second cells 208b travels downstream within the second cells 208b and flows out from the second end surface 206 on the downstream side. In addition, in this embodiment, the first end surface 204 is located on the upstream side of the exhaust gas, and the second end surface 206 is located on the downstream side of the exhaust gas; however, the distinction between the first end surface and the second end surface is for convenience, and the second end surface 206 may be located on the upstream side of the exhaust gas, and the first end surface 204 may be located on the downstream side of the exhaust gas.

There is no limitation on the shape of the end surfaces of the honeycomb structure, and it can be, for example, a round shape such as a circle, an ellipse, a racetrack shape, or an oval, a polygonal shape such as a triangle shape or a quadrangle, or other irregular shape. The honeycomb structure shown in the figure has a circular end surface shape and is cylindrical as a whole.

There is no particular limitation on the height of the honeycomb structure (the length from the first end surface to the second end surface), and it may be appropriately set depending on the application and required performance. The height of the honeycomb structure can be, for example, 40 mm to 450 mm. There is also no particular limitation on the relationship between the height of the honeycomb structure and the maximum diameter of each end surface (which refers to the maximum length among the diameters passing through the center of gravity of each end surface of the honeycomb structure). Therefore, the height of the honeycomb structure may be longer than the maximum diameter of each end surface, or the height of the honeycomb structure may be shorter than the maximum diameter of each end surface.

The area of each end surface of the honeycomb structure is not particularly limited, but may be, for example, 6200 to 93000 mm², typically 16200 to 73000 mm².

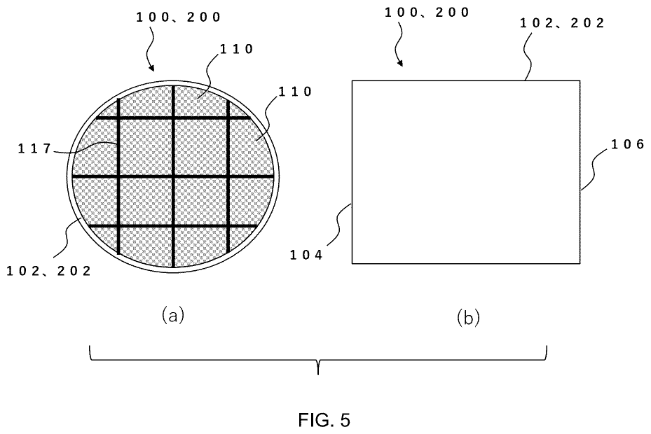

The honeycomb structure may be provided as a monolithic article. Also, as shown in FIG. 5, the honeycomb structures 100, 200 can be provided as a segment-joined body by preparing a plurality of pillar-shaped honeycomb structures as segments 110, and joining the outer peripheral side walls of the plurality of segments 110 together via a joining material 117 to form an integrated body. By providing the honeycomb structure as a segment-joined body, the thermal shock resistance can be improved.

There are no limitations on the shape of the cells in a cross section perpendicular to the direction in which the cells extend, but a quadrangle, hexagon, octagon, or a combination thereof is preferred. Among these, quadrangles and hexagons are preferred. By using such cell shapes, the pressure loss when exhaust gas flows through the honeycomb structure is reduced, and the purification performance of the catalyst is improved. From the viewpoint of increasing the structural strength, a square shape is particularly preferred.

The partition walls (typically the partition walls and the outer peripheral side wall) contain silicon carbide and silicon, that is, the partition walls (typically the partition walls and the outer peripheral side wall) comprise a silicon-silicon carbide composite material. Silicon-silicon carbide composite materials contain silicon carbide particles as aggregates and silicon as a binder that bonds the silicon carbide particles, and preferably, the silicon carbide particles are bonded together by silicon so as to form pores among the silicon carbide particles. The partition walls (typically the partition walls and the outer peripheral side walls) containing a silicon-silicon carbide composite material is advantageous in improving the heat resistance, thermal shock resistance, and oxidation resistance of the honeycomb structure. Assuming the total mass concentration of the silicon carbide and the silicon in the partition walls (typically the partition walls and the outer peripheral side wall) is E₁% by mass, it is preferable that 60≤E₁≤95 be satisfied, and more preferable that 70≤E₁≤92.5 be satisfied. It is advantageous in terms of strength if E₁ is 60 or more, and it is advantageous in terms of ease of production if E₁ is 95 or less.

When the partition walls (typically the partition walls and the outer peripheral side wall) contains a silicon-silicon carbide composite material, assuming a part by mass of the silicon carbide with respect to a total of 100 parts by mass of the silicon carbide and the silicon in the partition walls (typically the partition walls and the outer peripheral side wall) is D₁, it is preferable that 70≤D₁≤95 be satisfied, more preferable 75≤D₁≤92.5 be satisfied. It is advantageous in terms of strength if D₁ is 70 or more. It is advantageous in terms of strength and thermal conductivity if D₁ is 95 or less.

Furthermore, the partition walls (typically the partition walls and the outer peripheral side wall) comprise aluminum oxide, silicon oxide and strontium oxide as the firing aid. The inclusion of aluminum oxide, silicon oxide and strontium oxide as the firing aid is advantageous in that it promotes the melting of silicon. Further, assuming the total parts by mass of the aluminum oxide, the silicon oxide, and the strontium oxide with respect to the total of 100 parts by mass of the silicon carbide and the silicon in the partition walls (typically the partition walls and the outer peripheral side walls) is T₁, and a part by mass of the aluminum oxide with respect to the total of 100 parts by mass of the silicon carbide and the silicon in the partition walls (typically the partition walls and the outer peripheral side wall) is A₁, the thermal expansion of the honeycomb structure can be significantly suppressed by satisfying 0.045≤A₁/T₁.

From the viewpoint of suppressing thermal expansion of the honeycomb structure, the partition walls (typically the partition walls and the outer peripheral side wall) preferably satisfy 0.050≤A₁/T₁, and more preferably satisfy 0.055≤A₁/T₁. On the other hand, from the viewpoint of increasing the thermal conductivity of the honeycomb structure, it is preferable that the partition walls (typically the partition walls and the outer peripheral side wall) satisfy A₁/T₁≤0.200, more preferably A₁/T₁≤0.175, and even more preferably A₁/T₁≤0.150. Increasing the thermal conductivity of the honeycomb structure is advantageous in terms of thermal shock resistance since it suppresses the occurrence of temperature differences within the structure.

Therefore, in order to suppress the thermal expansion of the honeycomb structure and increase the thermal conductivity, it is preferable that the partition walls (typically the partition walls and the outer peripheral side wall) satisfy, for example, 0.045≤A₁/T₁≤0.200, more preferably 0.050≤A₁/T₁≤0.175, and even more preferably 0.055≤A₁/T₁≤0.150.

When the partition walls (typically the partition walls and the outer peripheral side wall) comprise aluminum oxide, silicon oxide, and strontium oxide as the firing aid, assuming the total parts by mass of the aluminum oxide, the silicon oxide, and the strontium oxide with respect to the total of 100 parts by mass of the silicon carbide and the silicon in the partition walls (typically the partition walls and the outer peripheral side wall) is T₁, and the parts by mass of silicon oxide with respect to the total of 100 parts by mass of the silicon carbide and the silicon in the partition walls (typically the partition walls and the outer peripheral side wall) is B₁, It is preferable that 0.70≤B₁/T₁≤0.90 be satisfied, more preferable that 0.725≤B₁/T₁≤0.875 be satisfied, and even more preferable that 0.75≤B₁/T₁≤0.85 be satisfied. By setting B₁/T₁ within this range, the silicon can be easily melted, and the advantages of strength and thermal conductivity are obtained.

When the partition walls (typically the partition walls and the outer peripheral side wall) comprise aluminum oxide, silicon oxide, and strontium oxide as the firing aid, assuming the total parts by mass of the aluminum oxide, the silicon oxide, and the strontium oxide with respect to the total of 100 parts by mass of the silicon carbide and the silicon in the partition walls (typically the partition walls and the outer peripheral side wall) is T₁, and a part by mass of the strontium oxide with respect the total of 100 parts by mass of the silicon carbide and the silicon in the partition walls is C₁, it is preferable that 0.050≤C₁/T₁≤0.200 be satisfied, more preferable that 0.060≤C₁/T₁≤0.190 be satisfied, and even more preferable that 0.070≤C₁/T₁≤0.180 be satisfied. By setting≤C₁/T₁ within this range, the silicon can be easily melted, and the advantages of strength and thermal conductivity are obtained.

When the partition walls (typically the partition walls and the outer peripheral side wall) comprise aluminum oxide, silicon oxide, and strontium oxide as the firing aid, assuming the total parts by mass of the aluminum oxide, the silicon oxide, and the strontium oxide with respect to the total of 100 parts by mass of the silicon carbide and the silicon in the partition walls (typically the partition walls and the outer peripheral side wall) is T₁, it is preferable that 10≤T₁≤40 be satisfied, it is more preferable that 12.5≤T₁≤35 be satisfied, and it is even more preferable that 15≤T₁≤30 be satisfied. By setting T₁ within this range, the advantage of ease of production can be obtained.

From the viewpoint of suppressing an increase in pressure loss, the partition walls (typically the partition walls and the outer peripheral side wall) have a lower limit of a porosity measured by mercury porosimetry of preferably 40% or more, more preferably 45% or more, and further more preferably 50% or more. In addition, from the viewpoint of ensuring strength, the partition walls (typically the partition walls and the outer peripheral side wall) preferably have an upper limit of the porosity measured by mercury porosimetry of 80% or less, more preferably 70% or less, and even more preferably 65% or less. Therefore, the partition walls (typically the partition walls and the outer peripheral side wall) preferably have a porosity measured by mercury porosimetry of, for example, 40 to 80%, more preferably 45 to 70%, and further more preferably 50 to 65%. As used herein, “porosity” is measured by the mercury porosimetry specified in JIS R1655: 2003. The porosity of the partition walls and the outer peripheral side wall is the average value measured by taking samples from a plurality of points of the honeycomb structure and measuring them.

It is desirable for the honeycomb structure to have small thermal expansion. Specifically, it is desirable for the average linear expansion coefficient measured in accordance with JIS R1618: 2002 when changing from 40° C. to 800° C. to be 5.5×10⁻⁶/K or less. By making the average linear expansion coefficient 5.5×10⁻⁶/K or less, the thermal stress during exhaust gas treatment and filter regeneration when the temperature of the honeycomb structure becomes high is reduced, and the thermal shock resistance is significantly improved. The average linear expansion coefficient is more preferably 5.4×10⁻⁶/K or less, and even more preferably 5.3×10⁻⁶/K or less. There is no particular restriction on the lower limit of the average linear expansion coefficient, but from the viewpoint of ease of production, the average linear expansion coefficient is preferably 3.0×10⁻⁶/K or more, more preferably 3.5×10⁻⁶/K or more, and even more preferably 4.0×10⁻⁶/K or more. Therefore, the average linear expansion coefficient is, for example, preferably 3.0×10⁻⁶/K or more and 5.5×10⁻⁶/K or less, more preferably 3.5×10⁻⁶/K or more and 5.4×10⁻⁶/K or less, and even more preferably 4.0×10⁻⁶/K or more and 5.3×10⁻⁶/K or less.

The average linear expansion coefficient of the honeycomb structure is measured by the following procedure: A rectangular pillar-shaped sample having a size of 3 mm×3 mm×15 mm (length in the direction in which the cells extend) is cut out from the center of the honeycomb structure in the radial and height directions, and the average linear expansion coefficient of the sample is measured under the above-mentioned temperature change conditions to obtain a measured value.

In addition, it is desirable for the honeycomb structure to have high thermal conductivity. Specifically, it is desirable for the thermal conductivity to be 3.0 W/(m·K) or more as measured at 50° C. according to the method of ASTM E1530. When the thermal conductivity is 3.0 W/(m·K) or more, the occurrence of temperature differences within the structure is suppressed, and thermal shock resistance is improved. In addition, it is possible to improve the removal performance when the PM trapped in the honeycomb structure is burned and removed for filter regeneration. The thermal conductivity is more preferably 3.3 W/(m·K) or more, and even more preferably 3.6 W/(m·K) or more. There is no particular upper limit to the thermal conductivity, but from the viewpoint of ease of production, the thermal conductivity is preferably 35.0 W/(m·K) or less, more preferably 30.0 W/(m·K) or less, and even more preferably 25.0 W/(m·K) or less. Therefore, the thermal conductivity is, for example, preferably 3.0 W/(m·K) or more and 35.0 W/(m·K) or less, more preferably 3.3 W/(m·K) or more and 30.0 W/(m·K) or less, and even more preferably 3.6 W/(m·K) or more and 25.0 W/(m·K) or less.

The thermal conductivity of the honeycomb structure is measured by the following procedure: A rectangular pillar-shaped sample having a size 35 mm×35 mm×20 mm (length in the direction in which the cells extend) is cut out from the center of the honeycomb structure in the radial and height directions, and the thermal conductivity of the sample is measured under the above-mentioned temperature conditions using a steady-state thermal conductivity measuring device conforming to ASTM E1530, thereby obtaining a measured value.

The cell density of the honeycomb structure (the number of cells per unit cross-sectional area perpendicular to the direction in which the cells extend) is not particularly limited, but may be, for example, 98 to 497 cells/square inch (15 to 77 cells/cm²), more preferably 129 to 400 cells/square inch (20 to 62 cells/cm²), and particularly preferably 148 to 348 cells/square inch (23 to 54 cells/cm²). Here, the cell density is calculated by dividing the total number of cells at one end surface of the honeycomb structure (if any sealed cells are present, the cells are counted as if they are not sealed) by the area of the one end surface excluding the outer peripheral side wall.

The upper limit of the average thickness of the partition walls in the honeycomb structure is preferably 500 μm or less, more preferably 400 μm or less, and further preferably 300 μm or less, from the viewpoint of pressure loss. Further, the lower limit of the average thickness of the partition walls in the honeycomb structure is preferably 100 μm or more, more preferably 125 μm or more, and further preferably 150 μm or more, from the viewpoint of strength. Therefore, the average thickness of the partition walls of the honeycomb structure is, for example, preferably 100 to 500 μm, more preferably 125 to 400 μm, and further preferably 150 to 300 μm. The thickness of the partition wall refers to a crossing length of a line segment that crosses the partition wall when the centers of gravity of adjacent cells are connected by this line segment in a cross-section orthogonal to the direction in which the cells extend (the height direction of the honeycomb structure). The average thickness of the partition wall is calculated based on the thicknesses of all the partition walls.

In addition, although it is difficult to quantify, it is preferable that the partition walls (typically the partition walls and the peripheral side wall) in the honeycomb structure contain one or both of sepiolite and montmorillonite added to the forming raw material composition as inorganic binders, and it is more preferable that they contain sepiolite.

### (2. Forming Raw Material Composition)

According to one embodiment of the present invention, there is provided a forming raw material composition that can be suitably used for producing a porous body such as the above-mentioned honeycomb structure. In one embodiment, the forming raw material composition contains silicon carbide, silicon, a pore-forming material, and a firing aid.

The raw materials such as silicon carbide, silicon, the pore-forming material, and the firing aid can be provided, for example, in the form of powder, and the forming raw material composition can be provided, for example, as a slurry in which these raw materials are dispersed in a dispersion medium.

When silicon carbide is in the form of powder, the median diameter (D50) of the silicon carbide particles constituting the silicon carbide powder is preferably 5 μm or more, more preferably 7.5 μm or more, and even more preferably 10 μm or more, from the viewpoint of reducing pressure loss. In addition, from the viewpoint of improving the collection performance as a filter, the median diameter (D50) of the silicon carbide particles constituting the silicon carbide powder is preferably 60 μm or less, more preferably 55 μm or less, and even more preferably 50 μm or less. Therefore, the median diameter (D50) of silicon carbide particles constituting the silicon carbide powder is, for example, preferably 5 to 60 μm, more preferably 7.5 to 55 μm, and even more preferably 10 to 50 μm. As used herein, the median diameter (D50) of silicon carbide particles refers to the 50% diameter when the cumulative particle size distribution on a volume basis of silicon carbide powder is measured by a laser diffraction/scattering method.

When silicon is in the form of powder, the median diameter (D50) of the silicon particles constituting the silicon powder is preferably 20 μm or less, more preferably 15 μm or less, and even more preferably 10 μm or less, from the viewpoint of increasing the strength of the porous body. Since the finer silicon particles are better, there is no particular lower limit for the median diameter (D50). However, from the viewpoint of availability, the median diameter (D50) of silicon particles is usually 1 μm or more. Therefore, the median diameter (D50) of the silicon particles constituting the silicon powder is, for example, preferably 1 to 20 μm, more preferably 1 to 15 μm, and even more preferably 1 to 10 μm. As used herein, the median diameter (D50) of silicon particles refers to the 50% diameter when the cumulative particle size distribution on a volume basis of silicon powder is measured by a laser diffraction/scattering method.

The inclusion of the silicon carbide and the silicon in the forming raw material composition is advantageous in terms of enhancing the heat resistance, thermal shock resistance, and oxidation resistance of the porous body. Assuming a part by mass of the silicon carbide with respect to the total of 100 parts by mass of the silicon carbide and the silicon contained in the forming raw material composition is D₂, it is preferable that 70≤D₂≤95 be satisfied, and it is more preferable that 72.5≤D₂≤90 be satisfied. It is advantageous in terms of strength if D₂ is 70 or more. It is advantageous in terms of strength and thermal conductivity if D₂ is 95 or less.

When the pore-forming material is in the form of powder, the median diameter (D50) of the pore-forming material particles constituting the pore-forming material powder is preferably 70 μm or less, more preferably 65 μm or less, and even more preferably 60 μm or less, from the viewpoint of PM collection performance. From the viewpoint of pressure loss, the median diameter (D50) of the pore-forming material particles constituting the pore-forming material powder is preferably 3 μm or more, more preferably 5 μm or more, and even more preferably 7.5 μm or more. Therefore, the median diameter (D50) of the pore-forming material particles constituting the pore-forming material powder is, for example, preferably 3 to 70 μm, more preferably 5 to 65 μm, and even more preferably 7.5 to 60 μm. As used herein, the median diameter (D50) of the pore-forming material particles refers to the 50% diameter when the cumulative particle size distribution on a volume basis of the pore-forming material powder is measured by a laser diffraction/scattering method.

When the firing aid is in the form of a powder, the median diameter (D50) of the firing aid particles constituting the firing aid powder is preferably 0.1 μm or more and 10 μm or less from the viewpoint of uniform powder mixing. As used herein, the median diameter (D50) of the firing aid particles refers to the 50% diameter when the cumulative particle size distribution on a volume basis of the firing aid powder is measured by a laser diffraction/scattering method.

In one embodiment, the firing aid contains aluminum oxide, silicon oxide, and strontium oxide. The firing aid containing aluminum oxide, silicon oxide, and strontium oxide is advantageous in terms of the ease of melting silicon.

From the viewpoint of obtaining a porous body with suppressed thermal expansion, assuming the total parts by mass of the aluminum oxide, the silicon oxide, and the strontium oxide with respect to the total of 100 parts by mass of the silicon carbide and the silicon contained in the forming raw material composition is T₂, and the total parts by mass of the aluminum oxide with respect to the total of 100 parts by mass of the silicon carbide and the silicon contained in the forming raw material composition is A₂, it is preferable that 0.20≤A₂/T₂ be satisfied, more preferable that 0.225≤A₂/T₂ be satisfied, and even preferable that 0.25≤A₂/T₂ be satisfied. On the other hand, from the viewpoint of obtaining a porous body with improved thermal conductivity, in the forming raw material composition, it is preferable that A₂/T₂≤0.70 be satisfied, more preferable that A₂/T₂≤0.65 be satisfied, and even more preferable that A₂/T₂≤0.60 is satisfied. Therefore, in the forming raw material composition, it is preferable that 0.20≤A₂/T₂≤0.70 be satisfied, more preferable that 0.225≤A₂/T₂≤0.65 be satisfied, and even more preferable that 0.25≤A₂/T₂≤0.60 be satisfied.

Assuming the total parts by mass of the aluminum oxide, the silicon oxide, and the strontium oxide with respect to the total of 100 parts by mass of the silicon carbide and the silicon contained in the forming raw material composition is T₂, and a part by mass of the silicon oxide with respect to the total of 100 parts by mass of the silicon carbide and the silicon contained in the forming raw material composition is B₂, it is preferable that 0.20≤B₂/T₂≤0.60 be satisfied, more preferable that 0.25≤B₂/T₂≤0.575 be satisfied, and even more preferable that 0.30≤B₂/T₂≤0.55 be satisfied. By setting B₂/T₂ within this range, there is an advantage that silicon melts easily and strength is obtained.

Assuming the total parts by mass of the aluminum oxide, the silicon oxide, and the strontium oxide with respect to the total of 100 parts by mass of the silicon carbide and the silicon contained in the forming raw material composition is T₂, and a part by mass of the strontium oxide with respect to the total of 100 parts by mass of the silicon carbide and the silicon contained in the forming raw material composition is C₂, it is preferable that 0.10≤C₂/T₂≤0.50 be satisfied, more preferable that 0.125≤C₂/T₂≤0.45 be satisfied, and even more preferable that 0.15≤C₂/T₂≤0.40 be satisfied. By setting C₂/T₂ within this range, there is an advantage that silicon melts easily and strength is obtained.

Assuming the total parts by mass of the aluminum oxide, the silicon oxide, and the strontium oxide with respect to the total of 100 parts by mass of the silicon carbide and the silicon contained in the forming raw material composition is T₂, it is preferable that 1.0≤T₂≤10.0 be satisfied, is more preferable that 1.5≤T₂≤9.0 be satisfied, and is even more preferable that 2.0≤T₂≤8.0 be satisfied. By setting T₂ within this range, there is an advantage that silicon melts easily and strength is obtained.

Assuming a part by mass of the pore-forming material with respect to the total of 100 parts by mass of the silicon carbide and the silicon contained in the forming raw material composition is G₂, it is preferable that 1.0≤G₂≤30.0 be satisfied, is more preferable that 2.0≤G₂≤28.0 be satisfied, and is even more preferable that 3.0≤G₂≤26.0 be satisfied. By setting G₂ within this range, there is an advantage that excellent PM collection performance and pressure loss can be obtained. As the pore-forming material, examples include, but are not limited to, graphite, foamed resin, wheat flour, starch, phenolic resin, polymethylmethacrylate, polyethylene, polymethacrylate, polyethylene terephthalate, and the like. As the pore-forming material, one type may be used alone, or two or more types may be used in combination.

It is preferable that the forming raw material composition comprises a binder. The binder may be either an organic binder or an inorganic binder. The organic binder is preferred from the viewpoint of ease of forming, while the inorganic binder is preferred from the viewpoint of obtaining strength of the structure after firing. As the inorganic binder, examples include, but are not limited to, magnesium silicate minerals having a 2:1 ribbon structure, smectite, alumina sol, silica sol, boehmite, gamma alumina, and attapulgite. As the inorganic binder, one type may be used alone, or two or more types may be used in combination. Among these, it is preferable to contain one or both of sepiolite and montmorillonite, and it is more preferable to contain sepiolite, in order to increase the strength of the formed body when the organic binder is burned off. As the organic binder, examples include, but are not limited to, methyl cellulose, hydroxypropyl methyl cellulose, hydroxypropoxyl cellulose, hydroxyethyl cellulose, carboxymethyl cellulose, polyvinyl alcohol, and the like. As the organic binder, one type may be used alone, or two or more types may be used in combination.

From the viewpoint of increasing the strength of the formed body when the organic binder is burned off, the content of the inorganic binder in the forming raw material composition is preferably 0.5 to 10.0 parts by mass, more preferably 1.0 to 8.0 parts by mass, and even more preferably 1.5 to 6.0 parts by mass, with respect to the total of 100 parts by mass of the silicon carbide and the silicon. For example, assuming a part by mass of the sepiolite with respect to the total of 100 parts by mass of the silicon carbide and the silicon is F₂, it is preferable that 0.5≤F₂≤5.0 be satisfied, more preferable that 1.0≤F₂≤4.25 be satisfied, and even preferable that 1.5≤F₂≤4.0 be satisfied.

From the viewpoints of improving the shape retention of the formed body, suppressing the occurrence of cracks due to abnormal heat generation during firing, and suppressing deformation by reducing the drying shrinkage of the molded body, and the like, the content of the organic binder in the forming raw material composition is preferably 3.0 to 9.0 parts by mass, more preferably 4.0 to 8.0 parts by mass, and even more preferably 5.0 to 7.0 parts by mass, with respect to the total of 100 parts by mass of the silicon carbide and the silicon.

The forming raw material composition preferably comprises a dispersion medium. The dispersion medium may be water or a mixed solvent of water and an organic solvent such as alcohol, with water being particularly preferred. From the viewpoints of improving quality stability during forming and suppressing deformation by reducing the amount of drying shrinkage of the molded body, the content of the dispersion medium in the forming raw material composition is preferably 20 to 60 parts by mass, more preferably 25 to 55 parts by mass, and even more preferably 30 to 50 parts by mass, with respect to the total of 100 parts by mass of the silicon carbide and the silicon. As used herein, the content of the dispersion medium in the forming raw material composition refers to a value measured by a loss on drying method.

If necessary, the forming raw material composition may comprise a surfactant. As the surfactant, ethylene glycol, dextrin, fatty acid soap, polyether polyol, or the like may be used. These may be used alone or in combination of two or more. The content of the surfactant when added to the forming raw material composition may be, for example, 0.01 to 1.0 parts by mass, with respect to the total of 100 parts by mass of the silicon carbide and the silicon.

### (3. Method for Producing Porous Body)

According to one embodiment of the present invention, there is provided a producing method that can be suitably used for producing a porous body such as the above-mentioned honeycomb structure. In one embodiment, the producing method comprises a forming step in which the above-mentioned forming raw material composition is extruded to prepare a formed body, and a firing step in which the formed body is fired to prepare a porous body. In one embodiment, the formed body has partition walls that define a plurality of cells extending from one end surface to the other end surface. A method for producing a honeycomb structure will be described in detail below as an example.

First, the above-mentioned forming raw material composition is kneaded to form a green body, and then the green body is extrusion molded through a die that defines the opening shape of a plurality of cells to prepare a honeycomb formed body which has an outer peripheral side wall, and a plurality of cells disposed on the inner peripheral side of the outer peripheral side wall, extending from a first end surface to a second end surface, and having opening on both of the first end surface and the second end surface.

The method for kneading the forming raw material composition is not particularly limited, and can be carried out by a method known in the art. For example, the forming raw material composition can be kneaded using a kneader, a vacuum kneader, or the like. The green body is formed to prepare a desired honeycomb formed body, typically a pillar-shaped honeycomb formed body. As a forming method, extrusion molding can be suitably used. During the extrusion molding, by using a die having the desired overall shape, cell shape, partition wall thickness, cell density, and the like, it is possible to prepare a honeycomb formed body having partition walls that define a plurality of cells extending from one end surface to the other end surface.

The honeycomb formed body may be dried before firing. The drying method is not particularly limited, and may be hot gas drying, microwave drying, dielectric drying, reduced pressure drying, vacuum drying, freeze drying, or the like. Among these, it is preferable to carry out dielectric drying, microwave drying, or hot gas drying alone or in combination. In addition, the drying conditions are not particularly limited, but preferably the drying temperature is 30 to 150° C. and the drying time is 1 minute to 2 hours. As used herein, the “drying temperature” means the temperature of the atmosphere in which drying is performed.

When producing a honeycomb structure having sealing portions, predetermined openings of the cells of the honeycomb formed body or the dried body obtained by drying the formed body are sealed with a sealing material. As a method for sealing the openings of the cells, a method of filling the openings of the cells with a sealing material may be used. The sealing material can be filled in accordance with a conventionally known method for producing a honeycomb structure having sealing portions. As a sealing portion forming raw material for forming the sealing portions, a sealing portion forming raw material used in a conventionally known method for producing a honeycomb structure can be used.

After drying the honeycomb formed body, a firing step is carried out to produce a honeycomb structure. A degreasing step may be performed before firing to burn off the organic binder. The conditions for the degreasing step and the firing step may be any known conditions according to the material composition of the honeycomb formed body, and no particular explanation is required, but specific examples of the conditions are given as below.

The degreasing step will now be described. The combustion temperature of the organic binder is about 200° C., and the combustion temperature of the pore-forming material is about 300 to 600° C. Therefore, the degreasing step may be carried out by heating the honeycomb formed body to a temperature in the range of about 200 to 1000° C. The heating time is not particularly limited, but is usually about 3 to 10 hours. The honeycomb formed body after the degreasing step is called a calcined body.

The degreasing process may be performed in an oxidizing atmosphere. However, when the formed body contains a large amount of organic binder, the organic binder may combust violently with oxygen during calcination, causing the temperature of the formed body to rise rapidly. Therefore, the calcination may be performed in an inert atmosphere such as N₂ or Ar to suppress abnormal temperature rise of the molded body. Suppression of this abnormal temperature rise is an important control when using raw materials with a large thermal expansion coefficient (vulnerable to thermal shock). For example, when 20 parts by mass or more of the organic binder is mixed with 100 parts by mass of the total of silicon carbide and silicon, it is preferable to carry out the calcination in an inert atmosphere.

The degreasing step and the subsequent firing step may be carried out as separate steps in the same or different furnaces, or may be successive steps in the same furnace. When degreasing and firing are carried out in different atmospheres, the former is also a preferred method, but from the standpoint of total firing time, furnace operating costs, and the like, the latter method is also preferred.

The firing conditions vary depending on the material of the columnar honeycomb structure, but are preferably heated in an inert atmosphere of nitrogen, argon, or the like at 1400 to 1500° C. for 1 to 10 hours. In addition, after firing, in order to improve durability, it is preferable to carry out an oxidation treatment for 1 to 20 hours at 1100 to 1300° C. The method of degreasing and firing is not particularly limited, and firing can be carried out using an electric furnace, a gas furnace, or the like.

When the honeycomb structure is provided as a segment-joined body, the segment-joined body can be produced, for example, by the following procedure. A plurality of pillar-shaped honeycomb structures are prepared as segments, and a joining material is applied to the side surfaces (joining surfaces) of each segment while a film for preventing adhesion of the joining material is attached to both end surfaces of each segment. Next, these segments are placed adjacent to each other with their sides facing each other, and adjacent segments are pressed together. After the pressing, any undried joining material protruding from at least one of the side surfaces, the first end surface, and the second end surface of the segment-joined body is scraped off, and the segment-joined body is then dried by heating. After drying, the film for preventing adhesion of the joining material is peeled off. In this manner, a segment-joined body is prepared in which the side surfaces of adjacent segments are joined together with the joining material.

The material for the film for preventing adhesion of the joining material is not particularly limited, but for example, synthetic resins such as polypropylene (PP), polyethylene terephthalate (PET), polyimide, or Teflon (registered trademark) can be suitably used. In addition, the film preferably has an adhesive layer, and the material of the adhesive layer is preferably an acryl-based resin, a rubber-based resin (for example, a rubber whose main component is natural rubber or synthetic rubber), or a silicone-based resin.

As the joining material, for example, a mixture (cement) prepared by mixing ceramic powder, a dispersion medium (for example, water), and, if necessary, additives such as a binder, a deflocculating agent, and a foaming resin may be used. Examples of ceramics include cordierite, mullite, zirconium phosphate, aluminum titanate, silicon carbide, silicon-silicon carbide composites (for example, Si-bonded SiC), cordierite-silicon carbide composites, zirconia, spinel, indialite, sapphirine, corundum, titania, and silicon nitride, and it is more preferable that the binder be made of the same material as that of the pillar-shaped honeycomb structure segments. Examples of the binder include polyvinyl alcohol and methyl cellulose.

Furthermore, the segment-joined body may be finished into a desired shape (for example, a cylindrical shape) by grinding the outer peripheral side wall, if desired. In this case, it is preferable to coat the outer peripheral side surface of the ground segment joint with a coating material, and then dry and heat treat the coating material to form a new outer peripheral side wall.

The coating material is not particularly limited, and any known outer periphery coating material can be used. Examples of the outer periphery coating material include inorganic raw materials such as inorganic fibers, colloidal silica, clay, and ceramic particles, which are mixed with additives such as an organic binder, a foamed resin, and a dispersant, as well as water to form a slurry. In addition, the method for applying the outer periphery coating material is not particularly limited, and any known method can be used.

When the honeycomb structure is used as a catalyst carrier, the partition walls can support a catalyst. The method for carrying a catalyst on the partition walls is not particularly limited, and any known method may be used. For example, a method in which a catalyst composition slurry is brought into contact with the porous partition walls, followed by drying and firing may be mentioned.

The catalyst composition slurry desirably contains a suitable catalyst depending on the application, including, but not limited to, oxidation catalysts, reduction catalysts and three-way catalysts for removing pollutants such as soot, nitrogen oxides (NOx), soluble organic fractions (SOF), hydrocarbons (HC) and carbon monoxide (CO). In particular, when the honeycomb structure is used as a filter such as a DPF or GPF, particulate matter (PM) such as soot and SOF in the exhaust gas is collected by the filter, so it is preferable to carry a catalyst that assists in the combustion of particulate matter. The catalyst may appropriately contain, for example, precious metals (Pt, Pd, Rh, and the like), alkali metals (Li, Na, K, Cs, and the like), alkaline earth metals (Ca, Ba, Sr, and the like), rare earths (Ce, Sm, Gd, Nd, Y, La, Pr, and the like), transition metals (Mn, Fe, Co, Ni, Cu, Zn, Zr, Sc, Ti, V, Cr, and the like), and the like.

### Examples

### <1. Production of Honeycomb Structure>

The following raw material powders were prepared:
Silicon carbide (SiC) with a median diameter (D50) of 30 μm
Silicon (Si) with a median diameter (D50) of 5 μm
Starch (pore-forming material) with a median diameter (D50) of 35 μm
Hydroxypropyl methylcellulose (organic binder)
Sepiolite (inorganic binder)
Montmorillonite (inorganic binder)
Aluminum oxide (Al₂O₃) (firing aid)
Silicon oxide (SiO₂) (firing aid)
Strontium oxide (SrO) (firing aid)

These were powder-mixed to satisfy the blending conditions shown in Table 1 according to the test number (Examples 1 to 12, Comparative Examples 1 and 2), and approximately 30 to 60 parts by mass of water was added with respect to the total of 100 parts by mass of the silicon carbide and the silicon, followed by kneading using a kneader. The resulting kneaded clay was extruded from a predesigned die of an extrusion molding machine to form a rectangular parallelepiped honeycomb formed body. The honeycomb formed body had an outer peripheral side wall, and partition walls disposed on the inner peripheral side of the outer peripheral side wall and defining a plurality of cells extending from one end surface to the other end surface.

The honeycomb formed body was microwave dried, and then dried at 120° C. for 2 hours using a hot gas dryer, and processed as necessary, such as cutting off a predetermined amount of both end surfaces, to obtain a honeycomb dried body. Next, the honeycomb dried body was placed in a continuous electric furnace and degreased (burning and removal of the organic binder) by heating for 5 hours in an air atmosphere at 450° C. or less, to obtain a honeycomb degreased body. Next, the honeycomb degreased body was fired in an Ar atmosphere at 1450° C. for 2 hours to obtain a honeycomb structure. The obtained honeycomb structure was a rectangular parallelepiped having a length of 35 mm×a width of 35 mm×a height (in the direction in which the cells extend) of 150 mm, an average partition wall thickness of 305 μm, a square cross-sectional shape of the cells, and a cell density of 44 cells/cm². In addition, a required number of the honeycomb formed bodies and honeycomb structures were produced for the evaluation of the following properties.

TABLE 1

| | Forming raw material composition | | | | | | | | | | | | |
|---|---|---|---|---|---|---|---|---|---|---|---|---|---|
| | | | Pore- | | | In- | (Al₂O₃ + | | | | | | |
| | SiC/ | | forming | Organic | | organic | SiO₂ + | Al₂O₃/ | SiO₂/ | SrO/ | | | |
| | (SiC + | Si/ | material/ | binder/ | | binder/ | SrO)/ | (SiC + | (SiC + | (SiC + | | | |
| | Si) | (SiC + | (SiC + Si) | (SiC + | | (SiC + | (SiC + Si) | Si) | Si) | Si) | | | |
| | [% by | Si) | [% by | Si) | Inorganic | Si) | [% by | [% by | [% by | [% by | | | |
| Test | mass] = | [% by | mass] = | [% by | binder | [% by | mass] = | mass] = | mass] = | mass] = | | | |
| No. | D₂ | mass] | G₂ | mass] | type | mass] | T₂ | A₂ | B₂ | C₂ | A₂/T₂ | B₂/T₂ | C₂/T₂ |
| Example 1 | 85 | 15 | 24 | 6.0 | Sepiolite | 3.0 | 6.0 | 1.4 | 3.0 | 1.6 | 0.237 | 0.497 | 0.265 |
| Example 2 | 85 | 15 | 24 | 6.0 | Sepiolite | 3.0 | 7.0 | 2.6 | 2.9 | 1.5 | 0.376 | 0.407 | 0.217 |
| Example 3 | 85 | 15 | 24 | 6.0 | Sepiolite | 3.0 | 8.0 | 3.6 | 2.8 | 1.5 | 0.455 | 0.356 | 0.190 |
| Example 4 | 85 | 15 | 24 | 6.0 | Sepiolite | 3.0 | 9.0 | 4.6 | 2.8 | 1.5 | 0.516 | 0.316 | 0.168 |
| Example 5 | 85 | 15 | 24 | 6.0 | Montmorillonite | 3.0 | 5.0 | 1.6 | 2.2 | 1.2 | 0.312 | 0.450 | 0.238 |
| Example 6 | 85 | 15 | 24 | 6.0 | Montmorillonite | 3.0 | 6.0 | 2.2 | 2.5 | 1.3 | 0.363 | 0.417 | 0.221 |
| Example 7 | 85 | 15 | 24 | 6.0 | Montmorillonite | 3.0 | 7.0 | 3.1 | 2.5 | 1.3 | 0.445 | 0.363 | 0.192 |
| Example 8 | 85 | 15 | 24 | 6.0 | Montmorillonite | 3.0 | 8.0 | 4.3 | 2.4 | 1.3 | 0.534 | 0.304 | 0.161 |
| Example 9 | 85 | 15 | 24 | 6.0 | Sepiolite | 1.5 | 5.0 | 1.9 | 1.5 | 1.6 | 0.370 | 0.305 | 0.325 |
| Example 10 | 85 | 15 | 24 | 6.0 | Sepiolite | 4.5 | 7.0 | 1.9 | 3.8 | 1.3 | 0.272 | 0.537 | 0.191 |
| Example 11 | 80 | 20 | 3.8 | 6.0 | Montmorillonite | 3.0 | 2.8 | 0.6 | 0.8 | 1.3 | 0.228 | 0.298 | 0.474 |
| Example 12 | 85 | 15 | 12.5 | 6.0 | Montmorillonite | 3.0 | 3.8 | 0.9 | 1.6 | 1.3 | 0.235 | 0.426 | 0.339 |
| Compartive | 85 | 15 | 24 | 6.0 | Sepiolite | 3.0 | 6.0 | 0.3 | 3.7 | 2.0 | 0.042 | 0.624 | 0.333 |
| Example 1 | | | | | | | | | | | | | |
| Compartive | 85 | 15 | 24 | 6.0 | Montmorillonite | 3.0 | 4.0 | 0.7 | 2.1 | 1.1 | 0.182 | 0.535 | 0.283 |
| Example 2 | | | | | | | | | | | | | |

### <2. Evaluation of Properties of Honeycomb Structure>

The honeycomb structures obtained above were each subjected to the following characteristic evaluations.

### (2-1. Composition Analysis)

A 10 g partition wall sample was taken from the honeycomb structure, and the composition of the partition wall was analyzed using a sequential type X-ray fluorescence analyzer (Rigaku Corporation: Model ZSX Primus II), and the following were calculated. The results are shown in Table 2.
T₁: total parts by mass of the aluminum oxide, the silicon oxide, and the strontium oxide with respect to the total of 100 parts by mass of the silicon carbide and the silicon in the partition walls
A₁: parts by mass of the aluminum oxide with respect to the total of 100 parts by mass of the silicon carbide and the silicon in the partition walls
B₁: parts by mass of the silicon oxide with respect to the total of 100 parts by mass of the silicon carbide and the silicon in the partition walls
C₁: parts by mass of the strontium oxide with respect to the total of 100 parts by mass of the silicon carbide and the silicon in the partition walls
D₁: parts by mass of the silicon carbide with respect to the total of 100 parts by mass of the silicon carbide and the silicon in the partition walls
E₁: total mass concentration (% by mass) of the silicon carbide and the silicon in the partition walls

In addition, in view of the producing method, it is presumed that the outer peripheral side wall has the same composition as the partition walls.

### (2-2. Porosity)

Partition wall samples were taken from a plurality of locations on the honeycomb structure, and the porosity was determined using the mercury intrusion method specified in JIS R1655: 2003, and the average value was taken as the measured value.

### (2-3. Average Linear Expansion Coefficient)

A measurement sample was taken from the honeycomb structure, and the average linear expansion coefficient (CTE) was measured according to JIS R1618: 2002 when the temperature was changed from 40° C. to 800° C. by the above-mentioned procedure. The measurements were performed using a thermal analyzer (model TD5000SE) manufactured by Netsch Japan Co., Ltd. The results are shown in Table 2.

### (2-4. Thermal Conductivity)

Measurement samples were taken from the honeycomb structure, and the thermal conductivity was measured at 50° C. according to the ASTM E1530 method using the procedure described earlier. A steady-state thermal conductivity measuring instrument (model GH-1) manufactured by ADVANCE RIKO, Inc. was used for the measurement. The results are shown in Table 2.

### <3. Evaluation of Properties of Honeycomb Formed Body>

The honeycomb dried body during the preparation of the honeycomb structure was cut into a size of 35 mm×35 mm×20 mm (length in the direction in which the cells extend), and the structure after degreasing (burning and removal of the organic binder) was compressed in the direction in which the cells extend to measure the strength at break. The results are shown in Table 2.

TABLE 2

| | Honeycomb structure (porous body) | | | | | | | | | Honeycomb |
|---|---|---|---|---|---|---|---|---|---|---|
| | | | | | | SiC + | | | | formed |
| | | | | | | Si in | | | | body |
| | (Al₂O₃ + | | | | SiC/ | partition | | | Thermal | Strength |
| | SiO2 + SrO)/ | | | | (SiC + Si) | walls | | | con- | after burning |
| | (SiC + Si) | | | | [% by | [% by | | CTE | ductivity | of organic |
| Test | [% by mass] = | | | | mass] = | mass] = | Porosity | (40-800° C.) | (50° C.) | binder |
| No. | T₁ | A₁/T₁ | B₁/T₁ | C₁/T₁ | D₁ | E₁ | [%] | [ppm/K] | [W/mK] | [kPa] |
| Example 1 | 32.1 | 0.048 | 0.860 | 0.092 | 85.4 | 75.1 | 61.0 | 5.4 | 4.4 | 64.5 |
| Example 2 | 32.1 | 0.079 | 0.828 | 0.093 | 85.0 | 75.1 | 61.6 | 5.0 | 3.9 | 64.6 |
| Example 3 | 32.1 | 0.098 | 0.809 | 0.093 | 84.7 | 75.1 | 62.1 | 4.7 | 3.8 | 64.8 |
| Example 4 | 32.0 | 0.125 | 0.782 | 0.093 | 84.4 | 75.1 | 63.3 | 4.7 | 2.8 | 64.8 |
| Example 5 | 28.5 | 0.071 | 0.826 | 0.103 | 89.6 | 77.8 | 62.5 | 5.4 | 4.7 | 15.6 |
| Example 6 | 28.5 | 0.084 | 0.813 | 0.103 | 89.5 | 77.8 | 63.2 | 5.3 | 4.6 | 15.8 |
| Example 7 | 28.5 | 0.112 | 0.785 | 0.103 | 89.2 | 77.8 | 63.9 | 5.1 | 3.8 | 15.9 |
| Example 8 | 28.5 | 0.153 | 0.745 | 0.102 | 88.8 | 77.8 | 64.8 | 4.9 | 2.9 | 15.9 |
| Example 9 | 24.6 | 0.066 | 0.805 | 0.129 | 84.5 | 79.8 | 63.6 | 5.0 | 3.5 | 21.0 |
| Example 10 | 32.1 | 0.068 | 0.837 | 0.095 | 85.3 | 75.1 | 62.1 | 5.3 | 3.6 | 130.8 |
| Example 11 | 15.2 | 0.069 | 0.762 | 0.169 | 81.9 | 88.8 | 43.2 | 4.9 | 20.6 | 26.1 |
| Example 12 | 18.7 | 0.082 | 0.781 | 0.157 | 85.5 | 87.8 | 48.0 | 4.9 | 19.1 | 21.9 |
| Compartive | 32.1 | 0.016 | 0.891 | 0.093 | 85.7 | 75.1 | 60.1 | 6.0 | 5.3 | 64.3 |
| Example 1 | | | | | | | | | | |
| Compartive | 28.5 | 0.040 | 0.855 | 0.105 | 89.9 | 77.8 | 61.2 | 5.8 | 5.0 | 15.4 |
| Example 2 | | | | | | | | | | |

### <4. Discussion>

All of Examples 1 to 12 and Comparative Examples 1 and 2 were a honeycomb structure containing a silicon-silicon carbide composite material, and contained aluminum oxide, silicon oxide and strontium oxide as the firing aid. However, in Comparative Examples 1 and 2, the content ratio of aluminum oxide was too low, and A₁/T₁ was less than 0.045, so the average linear expansion coefficient was large. In addition, when comparing the Examples, it is understood that when A₁/T₁ is not too high (particularly when it is 0.120 or less), a thermal conductivity with high practical value can be obtained. Further, it is also clear that the strength after the organic binder is burned off is significantly improved by adding sepiolite to the forming raw material composition.

### DESCRIPTION OF REFERENCE NUMERALS

100: Honeycomb structure
102: Outer peripheral side wall
104: First end surface
106: Second end surface
108: Cell
110: Segment
112: Partition wall
117: Joining material
200: Honeycomb structure
202: Outer peripheral side wall
204: First end surface
206: Second end surface
208a: First cell
208b: Second cell
209: Sealing portion
212: Partition wall

1. A honeycomb structure, comprising partition walls that define a plurality of cells extending from one end surface to the other end surface,
wherein the partition walls comprise silicon carbide, silicon, and a firing aid,
wherein the firing aid comprises aluminum oxide, silicon oxide, and strontium oxide, and assuming a total parts by mass of the aluminum oxide, the silicon oxide, and the strontium oxide with respect to a total of 100 parts by mass of the silicon carbide and the silicon in the partition walls is T₁, and a part by mass of the aluminum oxide with respect to the total of 100 parts by mass of the silicon carbide and the silicon in the partition walls is A₁, 0.045≤A₁/T₁ is satisfied.

2. The honeycomb structure according to claim 1, wherein 0.045≤A₁/T₁≤0.200 is satisfied.

3. The honeycomb structure according to claim 1, wherein assuming a part by mass of the silicon oxide with respect to the total of 100 parts by mass of the silicon carbide and the silicon in the partition walls is B₁, 0.70≤B₁/T₁≤0.90 is satisfied.

4. The honeycomb structure according to claim 1, wherein assuming a part by mass of the strontium oxide with respect the total of 100 parts by mass of the silicon carbide and the silicon in the partition walls is C₁, 0.050≤C₁/T₁≤0.200 is satisfied.

5. The honeycomb structure according to claim 1, wherein 10≤T₁≤40 is satisfied.

6. The honeycomb structure according to claim 1, wherein assuming a part by mass of the silicon carbide with respect to the total of 100 parts by mass of the silicon carbide and the silicon in the partition walls is D₁, 70≤D₁≤95 is satisfied.

7. The honeycomb structure according to claim 1, wherein assuming a total mass concentration of the silicon carbide and the silicon in the partition walls is E₁% by mass, 60≤E₁≤95 is satisfied.

8. The honeycomb structure according to claim 1, wherein the partition walls comprise sepiolite.

9. The honeycomb structure according to claim 8, wherein assuming a part by mass of the sepiolite with respect to the total of 100 parts by mass of the silicon carbide and the silicon is F₁, 0.5≤F₁≤5.0 is satisfied.

10. The honeycomb structure according to claim 1, wherein a porosity of the partition walls is 40% or more.

11. The honeycomb structure according to claim 1, comprising sealing portions disposed at predetermined openings of the cells at the one end surface and at remaining openings of the cells at the other end surface.

12. The honeycomb structure according to claim 1, wherein an average linear expansion coefficient measured in accordance with JIS R1618: 2002 when a temperature is changed from 40° C. to 800° C. is 5.5×10⁻⁶/K or less.

13. The honeycomb structure according to claim 1, having a thermal conductivity of 3.0 W/(m·K) or more as measured at 50° C. in accordance with a method of ASTM E1530.

14. A forming raw material composition, comprising silicon carbide, silicon, a pore-forming material, and a firing aid,
wherein the firing aid comprises aluminum oxide, silicon oxide, and strontium oxide, and assuming a total parts by mass of the aluminum oxide, the silicon oxide, and the strontium oxide with respect to a total of 100 parts by mass of the silicon carbide and the silicon is T₂, and a part by mass of the aluminum oxide with respect to the total of 100 parts by mass of the silicon carbide and the silicon is A₂, 0.20≤A₂/T₂ is satisfied.

15. The forming raw material composition according to claim 14, wherein 0.20≤A₂/T₂≤0.60 is satisfied.

16. The forming raw material composition according to claim 14, wherein assuming a part by mass of the silicon oxide with respect to the total of 100 parts by mass of the silicon carbide and the silicon is B₂, 0.20≤B₂/T₂≤0.60 is satisfied.

17. The forming raw material composition according to claim 14, wherein assuming a part by mass of the strontium oxide with respect to the total of 100 parts by mass of the silicon carbide and the silicon is C₂, 0.10≤C₂/T₂≤0.50 is satisfied.

18. The forming raw material composition according to claim 14, wherein 1.0≤T₂≤10.0 is satisfied.

19. The forming raw material composition according to claim 14, wherein assuming a part by mass of the silicon carbide with respect to the total of 100 parts by mass of the silicon carbide and the silicon is D₂, 70≤D₂≤95 is satisfied.

20. The forming raw material composition according to claim 14, further comprising sepiolite.

21. The forming raw material composition according to claim 20, wherein assuming a part by mass of the sepiolite with respect to the total of 100 parts by mass of the silicon carbide and the silicon is F₂, 0.5≤F₂≤5.0 is satisfied.

22. The forming raw material composition according to claim 14, wherein assuming a part by mass of the pore-forming material with respect to the total of 100 parts by mass of the silicon carbide and the silicon is G₂, 1.0≤G₂≤30.0 is satisfied.

23. A method for producing a porous body, comprising:
a forming step in which the forming raw material composition according to claim 14 is extruded to prepare a formed body, and
a firing step in which the formed body is fired to prepare a porous body.

24. The method for producing a porous body according to claim 23, wherein the formed body comprises partition walls that define a plurality of cells extending from one end surface to the other end surface.
